(19) United States
(12) Patent Application Publication
(10) Pub. No.: US 2005/0159042 A1
(43) Pub. Date: Jul. 21, 2005

(54) Electronic device and cable thereof

(76) Inventors: Ching-Hui Yen, Kaohsiung City (TW); Shih-Hsiu Huang, Pingjen City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/000,656

(22) Filed: Nov. 30, 2004

(30) Foreign Application Priority Data
Dec. 24, 2003 (TW) 92136665

(51) Int. Cl. F16L 3/00; H02B 1/01

(52) U.S. Cl. 439/571

(57) ABSTRACT

An electronic device and a cable thereof. The electronic device includes a circuit board, a port, a support, and a cable. The port is disposed on the circuit board. The support abuts the port. The cable is combined with the port in a manner such that the cable abuts the support.

### BACKGROUND

The invention relates to an electronic device and a cable thereof, and in particular, to an electronic device with an easily assembled cable.

FIG. 1 shows connection of a port 3 and a cable 6 in an electronic device 1. The port 3 is disposed on a printed circuit board 2, and is fastened to a metallic shield or a support 5 via receiving bolts 4 to complete the assembly of the electronic device 1. To fix the cable 6 to the port 3, fixed bolts 62 in a body 61 of the cable 6 are threaded into the receiving bolts 4. By means of the combination of the cable 6 and the receiving bolts 4, the printed circuit board 2 can be grounded via the support 5, thus reducing electro-magnetic interference.

Nevertheless, since the assembly of the conventional electronic device is performed via the receiving bolts, the cost and assembly time are considerable.

### SUMMARY

In view of this, an object of an embodiment of the invention is to provide an electronic device with reduced cost and assembly-time.

Another object of an embodiment of the invention is to provide a cable that is convenient for the assembly of the electronic device.

Accordingly, an embodiment of the invention provides an electronic device comprising a printed circuit board, a port, a support, and a cable. The port is disposed on the circuit board. The support abuts the port. The cable is combined with the port in a manner such that the cable abuts the support.

In a preferred embodiment, the cable comprises a body, a fixed bolt, and a washer. The fixed bolt is disposed in the body, and is passed through the support and threaded into the port. The washer, having two sides, abuts the body on one side and the support on the other side. The fixed bolt passes through the washer.

Furthermore, the washer is not flat and is made of elastic material. The support may be a metallic shield.

In another preferred embodiment, the washer comprises a first through hole, and the support comprises a second through hole corresponding to the first through hole. The port comprises a threaded hole corresponding to the second through hole. The fixed bolt is threaded into the threaded hole through the first through hole and the second through hole.

In an embodiment of the invention, a cable comprising a body, a fixed bolt, and a washer is provided. The fixed bolt is disposed in the body. The washer abuts the body. The fixed bolt passes through the washer.

In an embodiment of the invention, a connecting assembly comprising a port, a metallic plate, and a cable is provided. The metallic plate is connected to the port. The cable is combined with the port in a manner such that the cable abuts the support. The cable comprises a body and a fixed bolt. The fixed bolt is disposed in the body, and is passed through the metallic plate and threaded into the port.

### BRIEF DESCRIPTION OF THE DRAWINGS

Embodiments of the present invention can be more fully understood by reading the subsequent detailed description and examples with references made to the accompanying drawings, wherein:

FIG. 1 is a schematic view of a conventional electronic device;

FIG. 2 is a schematic view of an electronic device as disclosed in a first embodiment of this invention; and

FIG. 3 is a schematic view of an electronic device as disclosed in a second embodiment of this invention.

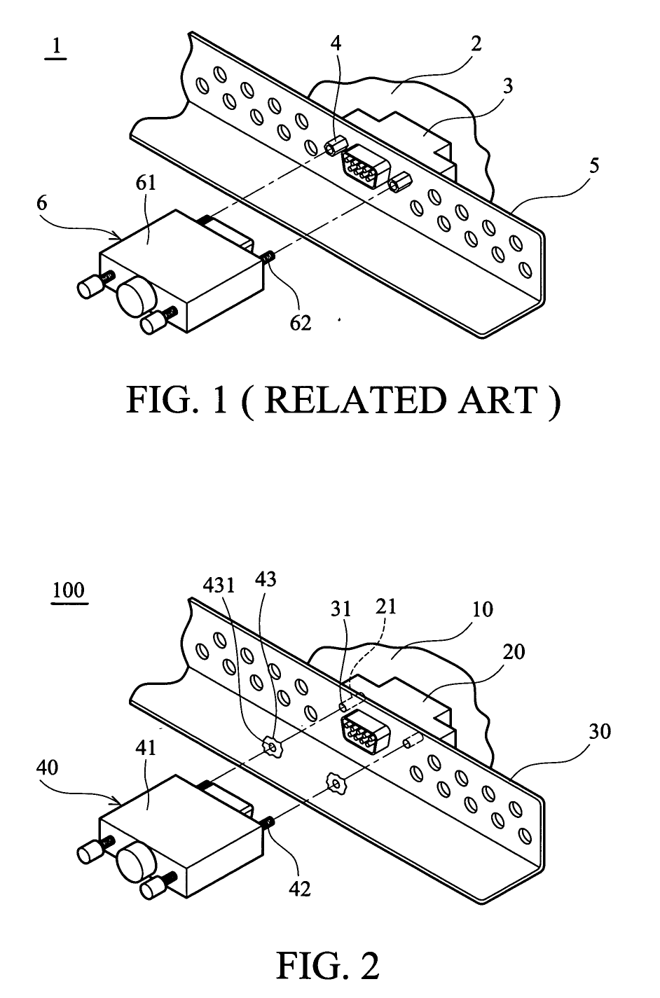

### DETAILED DESCRIPTION

First Embodiment

FIG. 2 shows an electronic device 100 as disclosed in a first embodiment of the invention. In this embodiment, the electronic device 100 comprises a printed circuit board 10, a port 20, a support 30, and a cable 40. The port 20 is disposed on the circuit board 10, and comprises two threaded holes 21. The support 30 abuts the port 20, and comprises two second through holes 31 corresponding to the threaded holes 21. Additionally, the support 30 may be a metallic shield (plate). The port 20, the support (metallic plate) 30, and the cable 40 constitute a connecting assembly of the invention.

The cable 40 is detachably connected to the port 20. The cable 40 when connected to the port 20 abuts the support 30. The cable 40 comprises a body 41, two fixed bolts 42, and two washers 43. The fixed bolts 42 are disposed in the body 41, and are passed through the washers and the second through holes 31 of the support 30 to be threaded into the threaded holes 21 of the port 20.

Each washer 43 abuts the body 41 of the cable 40 and the support 30 respectively. Each washer 43 comprises a first through hole 431 for receiving the fixed bolt 42. In order to maintain contact between the washer 43 and the support 30, the washer 43 is either not flat or is made of elastic material. The fixed bolts 42 can be grounded by contacting the support 30 via the washers 43. Additionally, the printed circuit board 10 can be grounded by contacting the support 30 via the port 20.

As stated above, the conventional cable and receiving bolts can be replaced by the cable of this embodiment, thus omitting the conventional receiving bolts. As a result, cost and assembly time can be reduced while maintaining original functions.

Second Embodiment

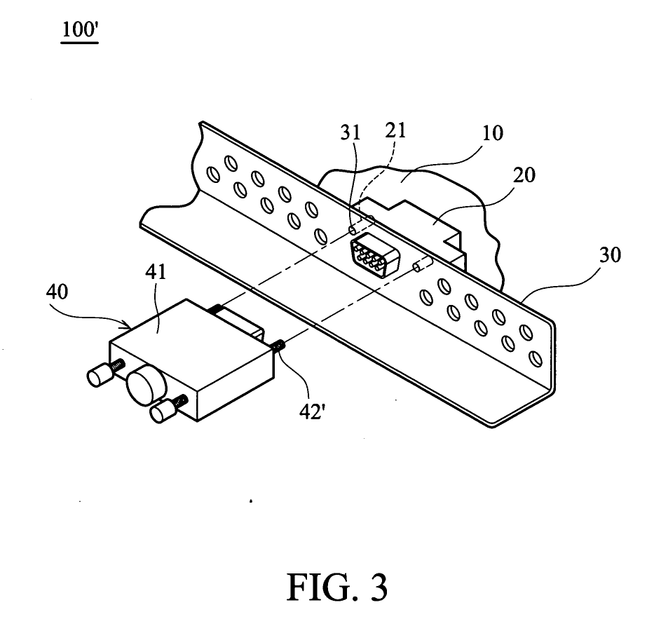

FIG. 3 shows an electronic device as disclosed in a second embodiment of the invention. This embodiment differs from the first embodiment in that the washers of the cable in the first embodiment are removed. That is, the cable 40′ of this embodiment does not comprise washers so that one end surface of each fixed bolt 42′ directly contacts the support 30.

In this embodiment, omitting the washers reduces the cost and number of elements; however, the fixed bolts must directly contact the support. Thus, the fixed bolt must be precisely manufactured or specially designed. For example, the cross section of the fixed bolt may be enlarged, thus enhancing the contact area between the fixed bolt and the support.

While the invention has been described by way of example and in terms of the preferred embodiment, it is to be understood that the invention is not limited to the disclosed embodiment. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An electronic device comprising:
a circuit board;
a port disposed on the circuit board;
a support abutting the port; and
a cable combined with the port in a manner such that the cable abuts the support.

2. The electronic device as claimed in claim 1, wherein the cable comprises:
a body; and
a fixed bolt, passing through the support, disposed in the body and threaded into the port.

3. The electronic device as claimed in claim 2, wherein the cable further comprises a washer abutting the body and the support respectively, and the fixed bolt passes through the washer.

4. The electronic device as claimed in claim 3, wherein the washer is made of elastic material.

5. The electronic device as claimed in claim 3, wherein the washer is not flat.

6. The electronic device as claimed in claim 3, wherein the washer comprises a first through hole, the support comprises a second through hole corresponding to the first through hole, and the port comprises a threaded hole corresponding to the second through hole, and the fixed bolt is threaded into the threaded hole through the first through hole and the second through hole.

7. The electronic device as claimed in claim 1, wherein the support is a metallic shield.

8. A cable comprising:
a body;
a fixed bolt disposed in the body; and
a washer abutting the body, wherein the fixed bolt passes through the washer.

9. The cable as claimed in claim 8, wherein the washer comprises a through hole, and the fixed bolt passes through the through hole.

10. The cable as claimed in claim 8, wherein the washer is made of elastic material.

11. The cable as claimed in claim 8, wherein the washer is not flat.

12. A connecting assembly comprising:
a port;
a metallic plate connected to the port; and
a cable combined with the port in a manner such that the cable abuts the metallic plate,
wherein the cable comprises:
a body; and
a fixed bolt, passing through the metallic plate, disposed in the body and threaded into the port.

13. The connecting assembly as claimed in claim 12, wherein the cable further comprises a washer abutting the body and the metallic plate respectively, and the fixed bolt passes through the washer.

14. The connecting assembly as claimed in claim 13, wherein the washer is made of elastic material.

15. The connecting assembly as claimed in claim 13, wherein the washer is not flat.

16. The connecting assembly as claimed in claim 13, wherein the washer comprises a first through hole, the metallic plate comprises a second through hole corresponding to the first through hole, and the port comprises a threaded hole corresponding to the second through hole, and the fixed bolt is threaded into the threaded hole through the first through hole and the second through hole.
